(19) United States
(12) Patent Application Publication
(10) Pub. No.: US 2026/0098630 A1
(43) Pub. Date: Apr. 9, 2026

(54) A TRACK LIGHTING SYSTEM

(71) Applicant: SIGNIFY HOLDING B.V., EINDHOVEN (NL)

(72) Inventors: OLIVER FRANCIS BURKE, EINDHOVEN (NL); TIES VAN BOMMEL, HORST (NL); MARCELLINUS PETRUS CAROLUS MICHAEL KRIJN, EINDHOVEN (NL); ROBERT JACOB PET, WAALRE (NL); LEENDERT TEUNIS ROZENDAAL, VALKENSWAARD (NL); BARTEL MARINUS VAN DE SLUIS, EINDHOVEN (NL)

(21) Appl. No.: 19/115,342

(22) PCT Filed: Sep. 13, 2023
(86) PCT No.: PCT/EP2023/075115

§ 371 Date: Mar. 26, 2025

(30) Foreign Application Priority Data
Sep. 26, 2022 (EP) 22197668.1

(51) Int. Cl. F21V 21/35; F21V 23/06; F21Y 115/10

(52) U.S. Cl. CPC F21V 21/35; F21V 23/06; F21Y 2115/10

(57) ABSTRACT

The invention provides a track lighting system comprising an elongated system track, a first connector element, and a LED luminaire configured to be connected to said elongated system track; wherein the elongated system track extends along an axis of elongation; wherein the first connector element is configured to mechanically and electrically connect said LED luminaire with said elongated system track, wherein the first connector element comprises a first luminaire connector and a first track connector; wherein the LED luminaire comprises a back panel facing the elongated system track when the LED luminaire is connected to said elongated system track, and a first luminaire track arranged in or on the back panel of the LED luminaire; wherein the first luminaire connector is mechanically and electrically connected to the first luminaire track and is movable along the first luminaire track; wherein the first track connector is mechanically and electrically connected to the elongated system track and is movable along of said elongated system track.

### FIELD OF THE INVENTION

The invention relates to a track lighting system comprising an elongated system track and a luminaire configured to be connected to said elongated system track. The invention further relates to said luminaire.

### BACKGROUND OF THE INVENTION

Track lighting systems, in which track-lighting devices such as luminaires are fitted on tracks, are well known to provide great flexibility and adaptability, because the number of track-lighting devices and/or the positioning of track-lighting devices may be varied on the track. Said track may also be known as a rail or lighting rail. See for example EP3719394A1.

Track lighting systems are typically implemented in professional venues. The luminaires currently implemented in track-lighting systems are mostly point sources. A typical example of such a track-lighting system is for example a retail environment with multiple spotlights on a lighting track. The spotlights are mechanically and electrically connected to said lighting track, and are movable to a desired location on said lighting track.

However, a current trend in the lighting business is to mount large-area luminaires to the track of a track-lighting system, such as for example a light panel or an elongated light bar. Another trend is that track-lighting systems are more and more implemented in domestic environments, such as within a living room and/or a kitchen.

As track-lighting systems become more popular and widespread, also in the domestic market, there is a clear need to find more safe & ergonomic solutions, and improvements, in connecting track-lighting devices to the track of a track lighting system, especially for large-area luminaires, such as e.g. light panels.

### SUMMARY OF THE INVENTION

It is an object of the invention to provide an improved track lighting system, which at least alleviates the problems and disadvantages mentioned above. Thereto, the present invention is set out in the appended independent and dependent claims.

Thereto, in a first aspect, the invention provides, a track lighting system comprising an elongated system track, a first connector element, and a LED luminaire configured to be connected to said elongated system track; wherein the elongated system track extends along an axis of elongation; wherein the first connector element is configured to mechanically and electrically connect said LED luminaire with said elongated system track, wherein the first connector element comprises a first luminaire connector and a first track connector; wherein the LED luminaire comprises a back panel facing the elongated system track when the LED luminaire is connected to said elongated system track, and a first luminaire track arranged in or on the back panel of the LED luminaire; wherein the first luminaire connector is mechanically and electrically connected to the first luminaire track and is movable along the first luminaire track; wherein the first track connector is mechanically and electrically connected to the elongated system track and is movable along of said elongated system track. Furthermore, the track lighting system comprises a second connector element; wherein the second connector element is configured to mechanically and electrically connect said LED luminaire with said elongated system track, wherein the second connector element comprises a second luminaire connector and a second track connector; wherein the second track connector is mechanically and electrically connected to the elongated system track and is movable along said elongated system track; wherein the second luminaire connector is mechanically and electrically connected to the first luminaire track and is movable along the first luminaire track; OR wherein the LED luminaire comprises a second luminaire track arranged in or on the back panel of the luminaire, and wherein the second luminaire connector is mechanically and electrically connected to the second luminaire track and is movable along the second luminaire track

The track lighting system according to the invention comprises an elongated system track and a LED (Light-Emitting Diode) luminaire. Throughout the application, the phrase luminaire may refer to the LED luminaire. Said elongated system track may alternatively be phrased as an elongated rail, an elongated guide rail, or an elongated rail track. Said track may be considered an electrical track suitable for track lighting system

The elongated system track is elongated (and extends) along an axis of elongation. Said axis of elongation may alternatively be phrased as a length axis. Said axis of elongation may be straight and/or curved.

The LED luminaire is configured to be connected (electrically and mechanically) to said elongated system track. Hence, the LED luminaire is a track lighting luminaire. The LED luminaire may be positioned on, or moved to, each position on the elongated system track (and the associated axis of elongation). Such adaptability and versatility is the common and known advantage of a track lighting system.

The present invention renders additional advantages in more ergonomically positioning a LED luminaire relative to an elongated system track of a track lighting system, especially when coping with a large-area LED luminaire. A large-area LED luminaire may for example be a panel luminaire, or a light guide plate. In an embodiment, the LED luminaire is a LED panel. In other examples, the luminaire may be an elongated LED bar.

Namely: The LED luminaire according to the present invention comprises a back panel facing the elongated system track when the LED luminaire is connected to said elongated system track, and a first luminaire track arranged in or on the back panel of the LED luminaire. Alternatively phrased, the first luminaire track may be arranged at the back panel. Hence, the LED luminaire (that is configured to be mechanically and electrically connected to the elongated system track of the track lighting system) comprises a first luminaire track itself.

Said back panel may alternatively phrased as a back surface. Said back panel may alternatively be phrased as a back side of the LED luminaire.

The track lighting system further comprises a first connector element comprising a first luminaire connector and a first track connector. The first luminaire connector is mechanically and electrically connected to the first luminaire track and is movable along the first luminaire track, and the first track connector is mechanically and electrically connected to the elongated system track and is movable along of said elongated system track.

Because the first connector element does not only comprise a first track connector for mechanically connecting the LED luminaire to said elongated system track and for moving the LED luminaire along said elongated system track, but also comprises a first luminaire connector mechanically connected to the first luminaire track and movable along the first luminaire track, the track lighting system according to the present invention enables an additional degree of freedom for the LED luminaire relative to the elongated system track, when the LED luminaire is mechanically (and electrically) connected to a certain position on the elongated system track. Hence, the LED luminaire can still be adjusted in position and/or orientation when connected to the elongated system track, without needing to move the connection point connecting the LED luminaire with the elongated system track. In other words, the first luminaire track enables the LED luminaire to be moved, along the first luminaire track, even when the LED luminaire is mechanically fixated (with the first track connector of the first connector element) to a certain location on the elongated system track.

Such an embodiment may be advantageous to provide more robustness and control to a LED luminaire of a track lighting system, especially for large-area luminaires that require a robust connection to the elongated system track, but may also benefit from increased adaptability relative to said elongated system track.

A large-area luminaire, for example the LED luminaire according to the invention, may e.g. comprise a planar light exit window opposite to the back panel, wherein the planar light exit window comprises a light exit window surface area, wherein the light exit window surface area is at least a factor four, preferably at least a factor eight, larger than a surface area of the elongated system track the LED luminaire is covering when connected to said elongated system track.

Hence, in aspects, the LED luminaire may comprise a planar light exit window opposite to the back panel. The LED luminaire may comprise a light source, wherein the light source is configured to convey light via said planar light exit window to the ambient.

The luminaire may further comprise at least one further light exit window, wherein the further light exit window may be arranged on the back panel and/or a side panel perpendicular or transverse to the back panel, wherein the light source is configured to convey light via said at least one further light exit window to the ambient.

In alternative examples, the LED luminaire may comprise the first track connector and/or the second track connector. Hence, in such examples, the first track connector and/or the second track connector may be integral (though movable) part of the LED luminaire.

As mentioned, the track lighting system comprises a second connector element; wherein the second connector element is configured to mechanically and electrically connect said LED luminaire with said elongated system track, wherein the second connector element comprises a second luminaire connector and a second track connector; wherein the second luminaire connector is mechanically and electrically connected to the first luminaire track and is movable along the first luminaire track; wherein the second track connector is mechanically and electrically connected to the elongated system track and is movable along said elongated system track. Such an embodiment may be advantageous, because the presence of a second connector element may provide a more robust connection between the LED luminaire and the elongated system track, while still enabling an additional degree of freedom for the LED luminaire to be adjusted relative to the elongated system track, when the LED luminaire is mechanically and electrically connected to a certain position on the elongated system track, i.e. enabling to adjust position and/or orientation of the LED luminaire when connected to the elongated system track. Alternatively, said phrasing “mechanically connected”may be phrased as “configured to mechanically connect”.

In examples, the track lighting system may comprise: a second luminaire track arranged in or on the back panel of the LED luminaire, wherein the first connector element may be mechanically and electrically connected to the first luminaire track and/or the second luminaire track, when engaging with the first luminaire track and/or the second luminaire track respectively, and may be movable along the first luminaire track and/or the second luminaire track respectively.

As mentioned, the track lighting system comprises a second connector element; wherein the second connector element is configured to mechanically and electrically connect said LED luminaire with said elongated system track, wherein the second connector element comprises a second luminaire connector and a second track connector; wherein the LED luminaire comprises a second luminaire track arranged in or on the back panel of the luminaire; wherein the second luminaire connector is mechanically and electrically connected to the second luminaire track and is movable along the second luminaire track; wherein the second track connector is mechanically and electrically connected the luminaire to the elongated system track and is movable along the elongated system track. Such an embodiment may be advantageous, because a second connector element and a second luminaire track may provide a more robust connection between the LED luminaire and the elongated system track, while still enabling an additional degree of freedom for the LED luminaire to be adapted relative to the elongated system track, when the LED luminaire is mechanically connected to a certain position on the elongated system track. Alternatively, said phrasing “mechanically connected” may be phrased as “configured to mechanically connect”.

In a related embodiment, the first luminaire track and the second luminaire track may be symmetrically arranged with respect to each other relative to a plane of symmetry perpendicular to the back panel. In a further related embodiment, the first luminaire track and the second luminaire track may be arranged in parallel on the back panel of the luminaire.

In a related embodiment, the first luminaire track and the second luminaire track may intersect each other on the back panel. In a related embodiment, the first luminaire track and the second luminaire track may be at least partly extending along a circular path, a curved path, or an elliptical path. In a related embodiment, the first luminaire track and the second luminaire track may be extending along a straight path.

The first luminaire track may for example extend between a first point and a second point on the back panel. Said points may be understood as locations on, or projected on, the back panel. Said first point and said second point may define a first line on the back panel. Said first line may follow a path that is straight, curved, circular, elliptical, square, etc.

The second luminaire track may for example extend between a third point and a fourth point on the back panel. Said third point and said fourth point may define a second line on the back panel. Said second line may follow a path that is straight, curved, circular, elliptical, square, etc.

Said first connector element and said second connector element may be the same, for example the same in dimensions. Said first connector element and said second connector element may be interchangeable.

In an embodiment, the track lighting system according to the invention is provided, wherein the first luminaire track is arranged transverse to the axis of elongation of the elongated system track; and/or wherein the second luminaire track is arranged transverse to the axis of elongation of the elongated system track. In a further embodiment, the first luminaire track is arranged perpendicular to the axis of elongation of the elongated system track; and/or wherein the second luminaire track is arranged perpendicular to the axis of elongation of the elongated system track.

In an embodiment, the first track connector and/or the second track connector may be click-fitted into the elongated system track.

In an embodiment, the first track connector comprises a first track connector locking mechanism to reversibly lock the first track connector to a position on the elongated system track; and/or wherein the first luminaire connector comprises a first luminaire connector locking mechanism to reversibly lock the first luminaire connector to a position on the first luminaire track.

In an embodiment, the second track connector comprises a second track connector locking mechanism to reversibly lock the second track connector to a position on the elongated system track; and/or wherein the second luminaire connector comprises a second luminaire connector locking mechanism to reversibly lock the second luminaire connector to a position on the second luminaire track.

In an embodiment, the first luminaire track and/or the second luminaire track may be recessed in the back panel.

In an embodiment, the first luminaire track comprises a first slit embedded in the back panel of the luminaire, wherein the first luminaire connector is mechanically confined in the first slit of the first luminaire track; and/or wherein the second luminaire track comprises a second slit embedded in the back panel of the luminaire, wherein the second luminaire connector is mechanically confined in the second slit of the second luminaire track.

In aspects, the first luminaire track and/or the second luminaire track may comprise a rail, a groove, an electrically conductive track. For example, the first connector element and/or the second connector element may engage with said rail, so as to be able to move along the first luminaire track and/or the second luminaire track. In aspects, the first luminaire track may comprise an anode, whereas the second luminaire track may comprise a cathode. In aspects, the back panel may comprise a polygonal shape.

In aspects, when the first luminaire track and the second luminaire track are not intersecting, the first luminaire track and/or the second luminaire track may be separated a distance D from each other. Said distance may be equal to at least a quarter of the shortest edge of the back panel. Said distance is for example preferable a factor 0.6 of a width of the luminaire, said width being defined by the back panel (or, if present, the width of a planar light exit window opposite to the back panel). Thereby, the first luminaire track may comprise an anode, whereas the second luminaire track may comprise a cathode.

In an embodiment, the track lighting system may comprise a third connector element, wherein the third connector element comprises a third luminaire connector and a third track connector; wherein the third luminaire connector is mechanically connected to the first luminaire track and is movable along the first luminaire track; wherein the third track connector is mechanically connected to the elongated system track and is movable along said elongated system track

In an embodiment, the track lighting system may comprise a third connector element, wherein the LED luminaire comprises third luminaire track arranged in or on the back panel; wherein the third connector element comprises a third luminaire connector and a third track connector, wherein the third luminaire connector is mechanically connected to the third luminaire track and is movable along the third luminaire track; wherein the third track connector is configured to connect the luminaire to the elongated system track and is movable along the elongated system track.

In an embodiment, the first connector element and/or the second connector element may comprise a respective controllable hinge, wherein the respective controllable hinge is configured to hinge the first luminaire connector and the first track connector relative to each other and/or wherein the respective controllable hinge is configured to hinge the second luminaire connector and the second track connector relative to each other.

It is an object of the invention to provide an improved track lighting system, which at least alleviates the problems and disadvantages mentioned above. Thereto, in a second aspect, the invention provides: A track lighting system comprising an elongated system track, a first connector element, and a LED luminaire configured to be connected to said elongated system track; wherein the elongated system track extends along an axis of elongation; wherein the first connector element is configured to mechanically and electrically connect said LED luminaire with said elongated system track, wherein the first connector element comprises a first luminaire connector and a first track connector; wherein the LED luminaire comprises a panel at least partly facing the elongated system track when the LED luminaire is connected to said elongated system track, and a first luminaire track arranged in or on the panel of the LED luminaire; wherein the first luminaire connector is mechanically and electrically connected to the first luminaire track and is movable along the first luminaire track; wherein the first track connector is mechanically and electrically connected to the elongated system track and is movable along of said elongated system track; wherein the panel is at least partially curved in three dimensions.

In an embodiment thereof, the first luminaire track is at least partly extending along a curved path over the panel. In an embodiment thereof, said curved path comprises a first straight path section and a second straight path section, wherein a centerline of the first straight path section is perpendicular to a centerline of the second straight path section.

In aspects, the track lighting system comprises (i) a ring shaped first luminaire track or (ii) the first luminaire track and the second luminaire track intersect each other, wherein the LED luminaire is rotatable over an axis A, wherein axis A extends perpendicular to said back side of said LED luminaire, preferably rotatable over at least 360 degrees.

In aspects, the invention further provides an improved luminaire assembly (or: Kit of Parts), wherein the luminaire assembly comprises a track lighting system comprising an elongated system track, a first connector element, and a LED luminaire configured to be connected to said elongated system track; wherein the elongated system track extends along an axis of elongation; wherein the first connector element is configured to mechanically and electrically connect said LED luminaire with said elongated system track, wherein the first connector element comprises a first luminaire connector and a first track connector; wherein the LED luminaire comprises a back panel facing the elongated system track when the LED luminaire is connected to said elongated system track, and a first luminaire track arranged in or on the back panel of the LED luminaire; wherein the first luminaire connector is mechanically and electrically connected to the first luminaire track and is movable along the first luminaire track; wherein the first track connector is mechanically and electrically connected to the elongated system track and is movable along of said elongated system track, wherein the track lighting system comprises a second connector element; wherein the second connector element is configured to mechanically and electrically connect said LED luminaire with said elongated system track, wherein the second connector element comprises a second luminaire connector and a second track connector; wherein the second track connector is mechanically and electrically connected to the elongated system track and is movable along said elongated system track; wherein the second luminaire connector is mechanically and electrically connected to the first luminaire track and is movable along the first luminaire track; OR wherein the LED luminaire comprises a second luminaire track arranged in or on the back panel of the luminaire, and wherein the second luminaire connector is mechanically and electrically connected.

In aspects, the invention further provides an improved LED luminaire suitable to be connected to an elongated system track extending along an axis of elongation, wherein the LED luminaire comprises a first connector element, a second connector element, a first luminaire track, and a back panel; wherein the first connector element is configured to mechanically and electrically connect said LED luminaire with said elongated system track, wherein the first connector element comprises a first luminaire connector and a first track connector; wherein the back panel is facing the elongated system track when the LED luminaire is connected to said elongated system track, wherein the first luminaire track is arranged in or on the back panel of the LED luminaire; wherein the first luminaire connector is mechanically and electrically connected to the first luminaire track and is movable along the first luminaire track; wherein the first track connector is mechanically and electrically connected to the elongated system track and is movable along of said elongated system track; wherein the second connector element is configured to mechanically and electrically connect said LED luminaire with said elongated system track, wherein the second connector element comprises a second luminaire connector and a second track connector; wherein the second track connector is mechanically and electrically connected to the elongated system track and is movable along said elongated system track; wherein the second luminaire connector is mechanically and electrically connected to the first luminaire track and is movable along the first luminaire track; OR wherein the LED luminaire further comprises a second luminaire track arranged in or on the back panel of the luminaire, and wherein the second luminaire connector is mechanically and electrically connected to the second luminaire track and is movable along the second luminaire track.

### BRIEF DESCRIPTION OF THE DRAWINGS

The invention will now be further elucidated by means of the schematic non-limiting drawings:

FIG. 1A and FIG. 1B depict schematically an embodiment of a track lighting system according to the invention;

FIG. 2A and FIG. 2B depict schematically an embodiment of a track lighting system according to the invention;

FIG. 3A and FIG. 3B depict schematically an embodiment of a track lighting system according to the invention;

FIG. 4 depicts schematically an embodiment of a plurality of luminaires suitable for a track lighting system according to the invention;

FIGS. 5A and 5B depicts schematically an embodiment of a track lighting system according to the invention.

### DETAILED DESCRIPTION OF THE EMBODIMENTS

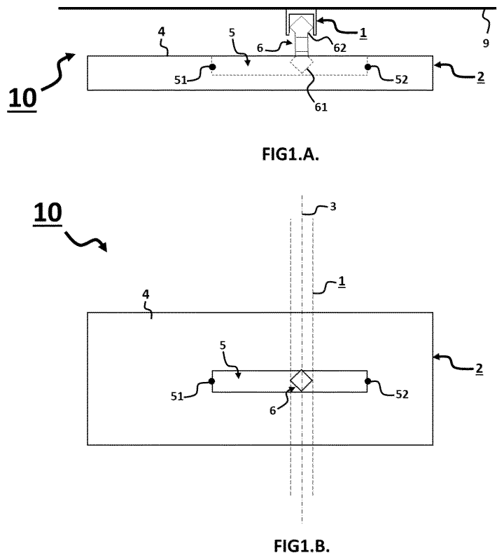

FIGS. 1A and 1B depict schematically, by non-limiting example, an embodiment of a track lighting system 10 according to the invention. FIG. 1A is a sideview. FIG. 1B is a corresponding top view.

The track lighting system 10 depicted in FIG. 1A-1B comprises an elongated system track 1 and a LED luminaire 2. The LED luminaire 2 is thereby connected to said elongated system track 1. The elongated system track 1 is mounted to a mounting surface 9, either mounted thereon or recessed therein. The mounting surface 9 may for example be a ceiling surface, or a wall surface. The elongated system track 1 extends along an axis of elongation 3. Here, the axis of elongation 3 is straight, but may alternatively be curved.

The LED luminaire 2 is both electrically as well as mechanically connected to said elongated system track 1. Such connections may be common for track lighting systems. Alternatively, the luminaire may be only mechanically connected to said elongated system track. Here, the LED luminaire 2 is a LED panel. Alternatively, the luminaire may for example be an elongated LED bar, or a lightguide plate.

The LED luminaire 2 comprises a back panel 4 facing the elongated system track 1 when the LED luminaire 2 is connected to said elongated system track 1. Said back panel 4 may be part of a housing of the LED luminaire 2. The LED luminaire 2 may optionally comprise a planar light exit window opposite to the back panel. The back panel may optionally comprise at least one further light exit window.

Still referring to FIG. 1A and FIG. 1B, according to the present invention, the LED luminaire 2 comprises a first luminaire track 5 arranged on the back panel 4. The first luminaire track 5 follows a straight path. The first luminaire track 5 extends between a first point 51 on the back panel 4 and a second point 52 on the back panel 4. Here, by non-limiting example, the first luminaire track 5 extends in a straight line between the first point 51 and the second point 52, but may alternatively be curved.

In aspects, by non-limiting example, the first luminaire track 5 is arranged transverse to the elongated system track 1, more specifically arranged perpendicular to the elongated system track 1, when the LED luminaire 2 is connected to said elongated system track 1. This enables the LED luminaire 2 to be adjusted in a direction transverse, particularly perpendicular, to the elongated axis 3 of the elongated system track, while the LED luminaire 2 is mechanically connected to the elongated system track 1 at a particular location thereon.

Still referring to FIG. 1A-1B, the track lighting system 10 further comprises a first connector element 6. The first connector element 6 comprises a first luminaire connector 61 and a first track connector 62.

Said first track connector 62 is mechanically and electrically connected to the elongated system track 1. The first track connector 62 is movable along said elongated system track 1 (e.g. to position the LED luminaire 2 to a position along said elongated system track 1). Such adaptability and versatility is the common and known advantage of a track lighting system. The first track connector 62 may for example be click-fitted to the elongated system track 1.

However, still referring to FIG. 1A and FIG. 1B, said first luminaire connector 61 is mechanically connected to the first luminaire track 5. The first luminaire connector 61 is also movable along the first luminaire track 5. Hence, the LED luminaire 2 has a track itself. More specifically, the first luminaire track 5 comprises a first slit embedded in the back panel of the LED luminaire 2, wherein the first luminaire connector 61 is mechanically confined in the first slit of the first luminaire track 5. Alternatively, said first luminaire track may be arranged on the back panel, such as a rail, ridge, or groove on the back panel.

Similarly, albeit optionally, the first luminaire connector may be electrically connected to the luminaire via said electrical connections in said slit. Yet alternatively, said first luminaire track may be a rail, wherein the first luminaire connector is configured to engage with said rail to form a mechanical connection, still allowing the luminaire and the first luminaire connector to move relative to each other along said rail.

Hence, the first connector element 6 connects the LED luminaire 2 mechanically and electrically to the elongated system track 1, by for example limiting the movement in the direction perpendicular to the back panel 4 or perpendicular to the elongated system track 1, but as the movement of the first luminaire connector 61 is movable along the first luminaire track 5, the LED luminaire 2 can still move in the direction(s) defined along the first luminaire track 5.

The present invention therefore presents additional advantages in more ergonomically positioning a LED luminaire 2 relative to an elongated system track 1 of a track lighting system 10, especially when coping with a large-area luminaire such as a LED panel 2. The LED luminaire 2 is fixed to the elongated system track 1 at a certain position, but can still be adjusted to move relative to said elongated system track 1 due to the first luminaire track 5, and the first luminaire connector 61 being movable in the first luminaire track 5.

In examples, still referring to FIG. 1A and FIG. 1B, albeit optionally and not depicted explicitly, the first track connector 62 comprises a first track connector locking mechanism to reversibly lock the first track connector 62 to a position on the elongated system track 1; and/or the first luminaire connector 61 comprises a first luminaire connector locking mechanism to reversibly lock the first luminaire connector 61 to a position on the first luminaire track 5.

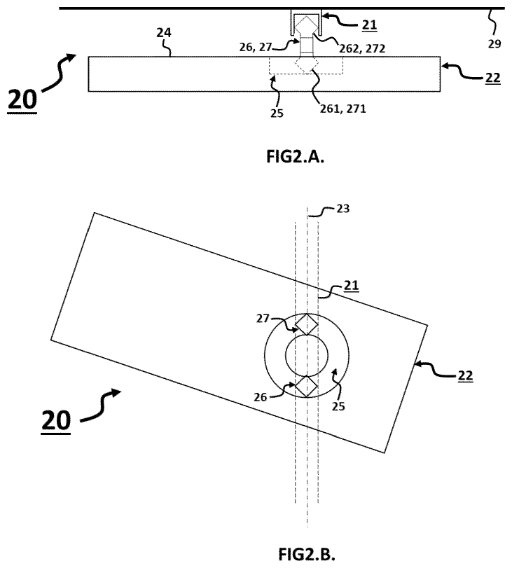

FIGS. 2A and 2B depict schematically, by non-limiting example, an embodiment of a track lighting system 20 according to the invention. FIG. 2A is a sideview. FIG. 2B is a corresponding top view.

The track lighting system 20 depicted in FIG. 2A-2B may be similar to the track lighting system 10 depicted in FIG. 1A-1B, but for the (path of the) first luminaire track arranged on the back panel, and the number of connector elements engaging with said first luminaire track.

The track lighting system 20 depicted in FIG. 2A-2B comprises an elongated system track 21 and a LED luminaire 22. The LED luminaire 22 is thereby connected to said elongated system track 21. The elongated system track 21 is mounted to a mounting surface 29. The elongated system track 21 extends along an axis of elongation 23. Here, the axis of elongation 3 is straight, but may alternatively be curved.

The LED luminaire 22 is both electrically as well as mechanically connected to said elongated system track 21. Such connections may be common for track lighting systems. Here, the LED luminaire 22 is a LED panel. Alternatively, the luminaire may for example be an elongated LED bar, or a lightguide plate. The LED luminaire 22 comprises a back panel 24 facing the elongated system track 21 when the LED luminaire 22 is connected to said elongated system track 21. The LED luminaire 22 may optionally comprise a planar light exit window opposite to the back panel.

Still referring to FIG. 2A and FIG. 2B, according to the present invention, the LED luminaire 22 comprises a first luminaire track 25 arranged on the back panel 24. The first luminaire track 25 extends in a circular path on the back panel (i.e. between a first point on the back panel 24 and a second point 52 on the back panel 24, the first point and second point being overlapping). Here, by non-limiting example, the first luminaire track 25 is a circle.

Still referring to FIG. 2A-2B, the track lighting system 20 further comprises a first connector element 26 and a second connector element 27. The first connector element 26 comprises a first luminaire connector 261 and a first track connector 262. The second connector element 27 comprises a first luminaire connector 271 and a first track connector 272. The first connector element 26 and the second connector element 27 are the same in configuration, such as e.g. their respective dimensions. Alternatively, the luminaire may comprise said first connector element and said second connector element, i.e. as integrated parts thereof.

Said first track connector 262 and said second track connector 272 are mechanically (and electrically) connected to the elongated system track 1. The first track connector 262 and the second track connector 272 are movable along said elongated system track 21 (e.g. to position the LED luminaire 22 to a position along said elongated system track 21). Thereby, the first track connector 262 and the second track connector 272 may for example be click-fitted to the elongated system track 21.

In alternative aspects, the first track connector may comprise an anode connection, whereas the second track connector may comprise a cathode connection, thereby both enabling an electrical connection to the elongated system track.

Still referring to FIG. 2A and FIG. 2B, said first luminaire connector 261 and said second luminaire connector are mechanically and electrically connected to the first luminaire track 25. The first luminaire connector 261 and the second luminaire connector 271 are also movable along the first luminaire track 25. Hence, the LED luminaire 22 has a track itself. More specifically, the first luminaire track 25 comprises a first slit embedded in the back panel of the LED luminaire 22, wherein the first luminaire connector 261 and the second luminaire connector 271 are mechanically confined in the first slit of the first luminaire track 25. Alternatively, said slit may be a groove or rail, for example.

Hence, the first connector element 26 and the second connector element 27 robustly connects the LED luminaire 22 mechanically to the elongated system track 21, by for example limiting the movement in the direction perpendicular to the back panel 24 or perpendicular to the elongated system track 21, but as the movement of the first luminaire connector 261 and the second luminaire connector 271 is movable along the first luminaire track 25, the LED luminaire 22 can still move in the direction(s) defined along the first luminaire track 25, i.e. the circular path. Hence, the LED luminaire 22 can rotate relative to the elongated system track 21, when the first track connector 262 and the second track connector 272 are connected to the elongated system track 21.

The present invention therefore presents additional advantages in more ergonomically positioning a LED luminaire 22 relative to an elongated system track 21 of a track lighting system 20, especially when coping with a large-area luminaire such as a LED panel 22. The LED luminaire 22 is fixed to the elongated system track 21 at a certain position, but can still be adjusted to move relative to said elongated system track 21 due to the first luminaire track 25, and the first luminaire connector 261 and second luminaire connector 271 being movable in the first luminaire track 25.

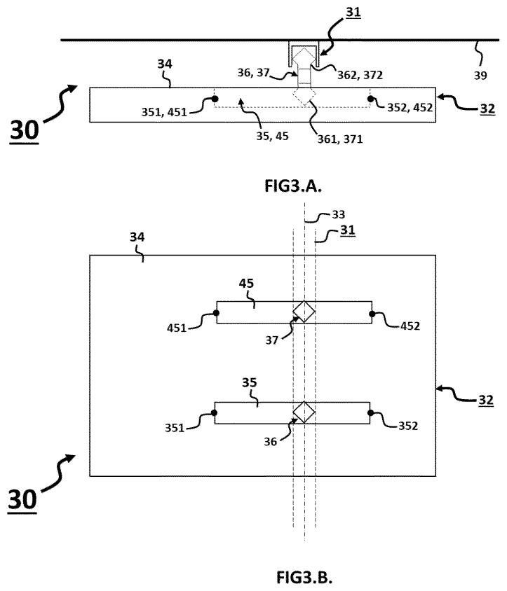

FIGS. 3A and 3B depict schematically, by non-limiting example, an embodiment of a track lighting system 30 according to the invention. FIG. 3A is a sideview. FIG. 3B is a corresponding top view.

The track lighting system 30 depicted in FIG. 3A-3B may be similar to the track lighting system 20 depicted in FIG. 2A-2B, but for the (number and path of the) luminaire track(s) arranged on the back panel, and but for the number of connector elements engaging with said luminaire track(s).

More specifically, the track lighting system 30 depicted in FIG. 3A-3B comprises an elongated system track 31 and a LED luminaire 32. The LED luminaire 32 is thereby connected to said elongated system track 31. The elongated system track 31 is mounted to a mounting surface 39. The elongated system track 31 extends along an axis of elongation 33. Here, the axis of elongation 33 is straight, but may alternatively be curved.

The LED luminaire 32 is electrically as well as mechanically connected to said elongated system track 31. Such connections may be common for track lighting systems. Here, the LED luminaire 32 is a square LED tile. Alternatively, the luminaire may for example be an elongated LED bar, a LED panel, or a lightguide plate. The LED luminaire 32 comprises a back panel 34 facing the elongated system track 31 when the LED luminaire 32 is connected to said elongated system track 31. The LED luminaire 32 may optionally comprise a planar light exit window opposite to the back panel.

Still referring to FIG. 3A and FIG. 3B, according to the present invention, the LED luminaire 32 comprises a first luminaire track 35 arranged on the back panel 34. The first luminaire track 35 extends in a straight path on the back panel 34 (i.e. between a first point 351 on the back panel 34 and a second point 352 on the back panel 34).

The LED luminaire 32 further comprises a second luminaire track 45 arranged on the back panel 34. The second luminaire track 45 extends in a straight path on the back panel 34 (i.e. between a third point 451 on the back panel 34 and a fourth point 452 on the back panel 34).

Here, by non-limiting example, the first luminaire track 35 and the second luminaire track 45 are symmetrical relative to a symmetry plane perpendicular to the back panel, i.e. a symmetry plane of a square through its center. Even further, here, the first luminaire track 35 and the second luminaire track 45 are arranged in parallel on the back panel of the LED luminaire 32. This enables a more robust connection with the elongated system track 31 and a more even distribution of loads.

Here, still referring to FIGS. 3A and 3B, the first luminaire track 35 and the second luminaire track 45 are arranged transverse, more specifically perpendicular, to the axis of elongation 33 of the elongated system track 31. This is not necessary. Alternatively, the first luminaire track and the second luminaire track may intersect on the back panel, or be at least partly circular or elliptical.

Still referring to FIG. 3A-3B, the track lighting system 30 further comprises a first connector element 36 and a second connector element 37. The first connector element 36 comprises a first luminaire connector 361 and a first track connector 362. The second connector element 37 comprises a first luminaire connector 371 and a first track connector 372. The first connector element 36 and the second connector element 37 are the same in configuration, such as e.g. their respective dimensions.

Said first track connector 362 and said second track connector 372 are mechanically (and electrically) connected to the elongated system track 31. The first track connector 362 and the second track connector 372 are movable along said elongated system track 31 (e.g. to position the LED luminaire 32 to a position along said elongated system track 31). Thereby, the first track connector 362 and the second track connector 372 may for example be click-fitted to the elongated system track 31.

In alternative aspects, the first track connector may comprise an anode connection, whereas the second track connector may comprise a cathode connection, thereby both enabling an electrical connection to the elongated system track.

Still referring to FIG. 3A and FIG. 3B, said first luminaire connector 361 is mechanically and electrically connected to the first luminaire track 35 and is movable along the first luminaire track 35. The second luminaire connector 371 is mechanically connected to the second luminaire track 45 and is movable along the second luminaire track 45. Hence, the LED luminaire 22 has two tracks itself. Said tracks may alternatively be considered slits, grooves, or rails.

Hence, the first connector element 36 and the second connector element 37 robustly connect the LED luminaire 32 both mechanically to the elongated system track 31, but as the movement of the first luminaire connector 361 and the second luminaire connector 371 are movable along the first luminaire track 35 and the second luminaire track 45 respectively, the LED luminaire 32 can still move in a direction(s) different to the elongated axis 33 of the elongated system track 31. Namely, the LED luminaire 32 can be adjusted in a direction perpendicular to the elongated axis 33 of the elongated system track 31, while the LED luminaire 32 is still connected to a certain position on the elongated system track 31. The present invention therefore presents additional advantages in more ergonomically positioning a LED luminaire 32 relative to an elongated system track 31 of a track lighting system 30.

In examples, still referring to FIG. 3A and FIG. 3B, albeit optionally and not depicted explicitly, the first track connector 362 comprises a first track connector locking mechanism to reversibly lock the first track connector 362 to a position on the elongated system track 31; and the second track connector 372 comprises a second track connector locking mechanism to reversibly lock the second track connector 372 to a position on the elongated system track 31.

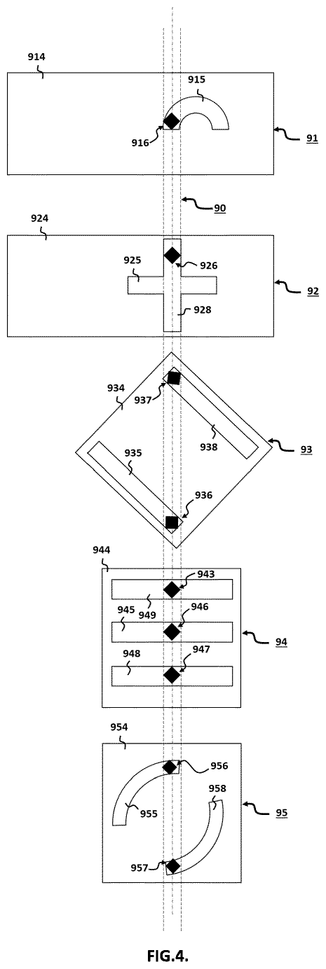

The track lighting systems 10, 20, 30 depicted respectively in FIGS. 1A-1B, 2A-2B, and 3A-3B are not limited. Other examples may be envisioned similarly. FIG. 4 depicts schematically, by non-limiting example, a top view of an elongated system track 90 to which five different LED luminaires 91, 92, 93, 94, 95 according to the invention are connected mechanically and optionally electrically. The connection is established by either a first connector element, or a first connector element and a second connector element, or a first connector element and a second connector element and a third connector element.

For example, the first exemplar LED luminaire 91 comprises a back panel 914 facing the elongated system track 90 (when the first exemplar luminaire 91 is connected to said elongated system track 90). The back panel 914 comprises a rectangular shape, but is not limited thereto. Said luminaire also comprises a first luminaire track 915 arranged on the back panel 914. The first luminaire track 915 extends between a first point on the back panel 914 and a second point on the back panel. More specifically, the first luminaire track 915 is curved, and follows the path of halve a circle. Alternatively, the path may be elliptical. The LED luminaire 91 also comprises a first connector element 916, albeit the first connector element 916 may be a separate device in assembly together with the LED luminaire 91 in a track lighting system. The first connector element 916 comprises a first luminaire connector configured to mechanically and electrically connect to the first luminaire track 915 and to be movable along the first luminaire track 915. The first connector element 916 comprises a first track connector configured to configured to mechanically and electrically connect to the elongated system track 90 and to be movable along said elongated system track 90.

For example, the second exemplar LED luminaire 92 comprises a back panel 924 facing the elongated system track 90 (when the second exemplar luminaire 92 is connected to said elongated system track 90). The back panel 924 comprises a rectangular shape, but is not limited thereto. Said LED luminaire 92 also comprises a first luminaire track 925 arranged on the back panel 924. The first luminaire track 925 extends between a first point on the back panel 924 and a second point on the back panel. Said LED luminaire 92 also comprises a second luminaire track 928 arranged on the back panel 924. The second luminaire track 928 extends between a third point on the back panel 924 and a fourth point on the back panel 924. More specifically, the first luminaire track 925 is straight, and follows the path of a straight line, whereas the second luminaire track 928 is straight, and follows the path of a straight line. The first luminaire track 925 and the second luminaire track 928 intersect at their center, thereby mutually creating a cross. The second exemplar LED luminaire 92 also comprises a first connector element 926, albeit the first connector element 926 may be a separate device in assembly together with the LED luminaire 92 in a track lighting system. The first connector element 926 comprises a first luminaire connector configured to mechanically and electrically connect to the first luminaire track 925 and/or the second luminaire track 925, and to be movable along the first luminaire track 925 and/or the second luminaire track 928. The first connector element 926 comprises a first track connector configured to configured to mechanically connect to the elongated system track 90 and to be movable along said elongated system track 90.

For example, the third exemplar LED luminaire 93 comprises a back panel 934 facing the elongated system track 90 (when the third exemplar luminaire 93 is connected to said elongated system track 90). The back panel 934 comprises a square shape, but is not limited thereto. Said LED luminaire 93 also comprises a first luminaire track 935 arranged on the back panel 934. The first luminaire track 935 extends between a first point on the back panel 934 and a second point on the back panel 934. Said luminaire 93 also comprises a second luminaire track 938 arranged on the back panel 934. The second luminaire track 938 extends between a third point on the back panel 934 and a fourth point on the back panel 934. More specifically, the first luminaire track 935 is straight, and follows the path of a straight line, whereas the second luminaire track 938 is straight, and follows the path of a straight line. The first luminaire track 935 and the second luminaire track are arranged in parallel on the back panel 934 of the luminaire 93. The first luminaire track 935 and the second luminaire track 938 are thereby symmetrical relative to a symmetry plane of the square shaped back panel 934. The third exemplar LED luminaire 93 also comprises a first connector element 936 and a second connector element 937, albeit the first connector element 936 and the second connector element 937 may be a separate device in assembly together with the LED luminaire 93 in a track lighting system. The first connector element 936 comprises a first luminaire connector configured to mechanically and electrically connect to the first luminaire track 935, and to be movable along the first luminaire track 935. The second connector element 937 comprises a second luminaire connector configured to mechanically connect to the second luminaire track 938, and to be movable along the second luminaire track 938. The first connector element 936 comprises a first track connector configured to configured to mechanically and electrically connect to the elongated system track 90 and to be movable along said elongated system track 90. The second connector element 938 comprises a second track connector configured to configured to mechanically connect to the elongated system track 90 and to be movable along said elongated system track 90.

For example, the fourth exemplar luminaire 94 comprises a back panel 944 facing the elongated system track 90 (when the fourth exemplar LED luminaire 94 is connected to said elongated system track 90). The back panel 944 comprises a square shape, but is not limited thereto. Said luminaire 94 also comprises a first luminaire track 945 arranged on the back panel 944. The first luminaire track 945 extends between a first point on the back panel 944 and a second point on the back panel 944. Said LED luminaire 94 also comprises a second luminaire track 948 arranged on the back panel 944. The second luminaire track 948 extends between a third point on the back panel 944 and a fourth point on the back panel 944. Said luminaire 94 also comprises a third luminaire track 949 arranged on the back panel 944. The third luminaire track 949 extends between a fifth point on the back panel 944 and a sixth point on the back panel 944. More specifically, the first luminaire track 945 is straight, and follows the path of a straight line, the second luminaire track 948 is straight, and follows the path of a straight line, the third luminaire track 949 is straight, and follows the path of a straight line. The first luminaire track 945, the second luminaire track 948, and the third luminaire track 949 are parallel to each other and arranged in parallel on the back panel 944. This fourth exemplar LED luminaire 94 also comprises a first connector element 946, a second connector element 947, and a third connector element 943. However, alternatively, the first connector element 946, the second connector element 947, and the third connector element 943 may be separate devices in assembly together with the LED luminaire 94 in a track lighting system. The first connector element 946 comprises a first luminaire connector configured to mechanically and electrically connect to the first luminaire track 945, and to be movable along the first luminaire track 945. The second connector element 947 comprises a second luminaire connector configured to mechanically and optionally electrically connect to the second luminaire track 948, and to be movable along the second luminaire track 948. The third connector element 943 comprises a third luminaire connector configured to mechanically and optionally electrically connect to the third luminaire track 949, and to be movable along the third luminaire track 949. The first connector element 946 comprises a first track connector configured to configured to mechanically connect to the elongated system track 90 and to be movable along said elongated system track 90. The second connector element 948 comprises a second track connector configured to configured to mechanically and optionally electrically connect to the elongated system track 90 and to be movable along said elongated system track 90. The third connector element 943 comprises a third track connector configured to configured to mechanically and optionally electrically connect to the elongated system track 90 and to be movable along said elongated system track 90. Alternatively, the first luminaire track, the second luminaire track, and the third luminaire track may intersect on the back panel.

For example, the fifth exemplar LED luminaire 95 comprises a back panel 954 facing the elongated system track 90 (when the fifth exemplar LED luminaire 95 is connected to said elongated system track 90). The back panel 934 comprises a square shape, but is not limited thereto. Said luminaire 95 also comprises a first luminaire track 955 arranged on the back panel 954. The first luminaire track 955 extends between a first point on the back panel 954 and a second point on the back panel 954. Said luminaire 95 also comprises a second luminaire track 958 arranged on the back panel 954. The second luminaire track 958 extends between a third point on the back panel 954 and a fourth point on the back panel 954. More specifically, the first luminaire track 955 is curved, and follows partially the path of a circle, whereas the second luminaire track 958 is curved, and follows partially the path of a circle. The first luminaire track 955 and the second luminaire track are arranged in parallel on the back panel 954 of the LED luminaire 95. The first luminaire track 955 and the second luminaire track 958 are thereby symmetrical relative to a symmetry plane perpendicular to the back panel 954, e.g. through the diagonal of the square shaped back panel 954. The fifth exemplar LED luminaire 95 is also configured to be connected with the elongated system track with a first connector element 956 and a second connector element 957. The first connector element 956 comprises a first luminaire connector configured to mechanically and electrically connect to the first luminaire track 955, and to be movable along the first luminaire track 955. The second connector element 957 comprises a second luminaire connector configured to mechanically and optionally electrically connect to the second luminaire track 958, and to be movable along the second luminaire track 958. The first connector element 956 comprises a first track connector configured to configured to mechanically and electrically connect to the elongated system track 90 and to be movable along said elongated system track 90. The second connector element 958 comprises a second track connector configured to configured to mechanically and optionally electrically connect to the elongated system track 90 and to be movable along said elongated system track 90.

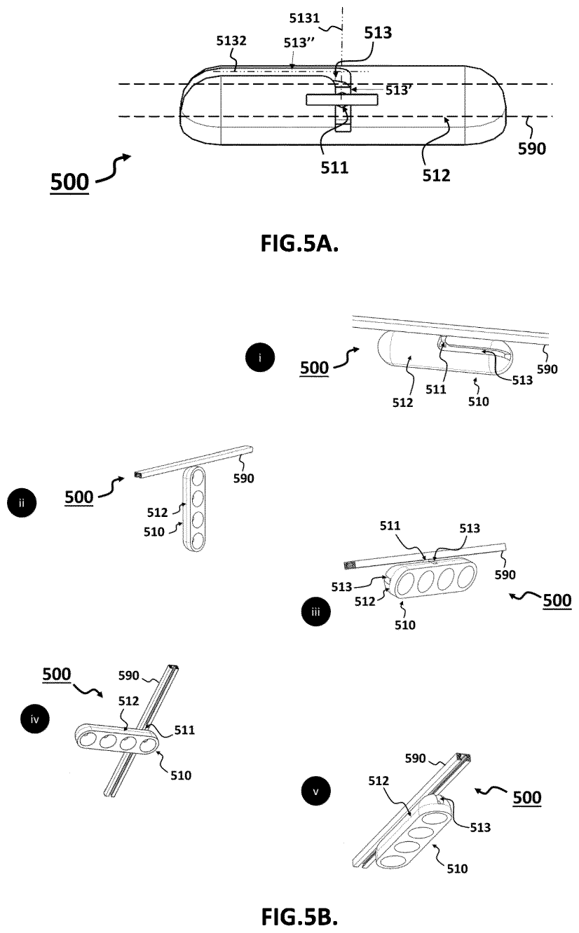

FIGS. 5A and 5B depict schematically, by non-limiting example, an embodiment of a track lighting system 500 according to the invention. FIG. 5A is a sideview. FIG. 5B depicts a perspective views of the corresponding device in various orientations relative to an elongated system track, referred to as (i), (ii), (iii), (iv), (v), or alternatively phrased as options or modes relative to an elongated system track.

Referring to FIGS. 5A and 5B, the track lighting system 500 comprises an elongated system track 590, a first connector element 511, and a LED luminaire 510 configured to be connected to said elongated system track 590. The elongated system track extends along an axis of elongation.

The first connector element 511 mechanically and electrically connects said LED luminaire 510 with said elongated system track 590. The first connector element 511 comprises a first luminaire connector and a first track connector. The first connector element may be similar to the first connector element as described for the embodiments depicted in FIGS. 1 to 4.

The LED luminaire 510 comprises a panel 512 at least partly facing the elongated system track 590 when the LED luminaire 510 is connected to said elongated system track 590. The panel 512 may be part of a housing of the luminaire. The panel 512 may alternatively be a luminaire surface, or a luminaire envelope.

The LED luminaire 510 further comprises a first luminaire track 513 arranged in or on the panel 513 of the LED luminaire 510. The first luminaire connector is mechanically and electrically connected to the first luminaire track 513 and is movable along the first luminaire track 513. The first track connector is mechanically and electrically connected to the elongated system track 590 and is movable along of said elongated system track 590.

Here, the panel (or: the luminaire surface) is at least partially curved in three dimensions. The LED luminaire may for example be a LED spot with a curved shape.

Here, the first luminaire track 513 is at least partly extending along a curved path over the panel 512 (or: luminaire surface).

Optionally, but depicted in FIG. 5A, said curved path comprises a first straight path section 513′ and a second straight path section 513″. A centerline 5131 of the first straight path section 513′ is perpendicular to a centerline 5132 of the second straight path section.

1. A track lighting system comprising an elongated system track, a first connector element, and a LED luminaire configured to be connected to said elongated system track;
wherein the elongated system track extends along an axis of elongation;
wherein the first connector element is configured to mechanically and electrically connect said LED luminaire with said elongated system track, wherein the first connector element comprises a first luminaire connector and a first track connector;
wherein the LED luminaire comprises a back panel facing the elongated system track when the LED luminaire is connected to said elongated system track, and a first luminaire track arranged in or on the back panel of the LED luminaire;
wherein the first luminaire connector is mechanically and electrically connected to the first luminaire track and is movable along the first luminaire track;
wherein the first track connector is mechanically and electrically connected to the elongated system track and is movable along of said elongated system track;
wherein the track lighting system comprises a second connector element;
wherein the second connector element is configured to mechanically and electrically connect said LED luminaire with said elongated system track, wherein the second connector element comprises a second luminaire connector and a second track connector;
wherein the second track connector is mechanically and electrically connected to the elongated system track and is movable along said elongated system track;
wherein the second luminaire connector is mechanically and electrically connected to the first luminaire track and is movable along the first luminaire track; OR
wherein the LED luminaire comprises a second luminaire track arranged in or on the back panel of the luminaire, and wherein the second luminaire connector is mechanically and electrically connected to the second luminaire track and is movable along the second luminaire track.

2. The track lighting system according to claim 1, wherein the first luminaire track and the second luminaire track are symmetrically arranged with respect to each other relative to a plane of symmetry perpendicular to the back panel.

3. The track lighting system according to claim 1, wherein the first luminaire track and the second luminaire track are arranged in parallel on the back panel of the luminaire.

4. The track lighting system according to claim 1, wherein the first luminaire track and/or the second luminaire track is recessed in the back panel.

5. The track lighting system according to claim 1, wherein the first luminaire track and the second luminaire track intersect each other on the back panel

6. The track lighting system according to claim 1, wherein the first luminaire track and the second luminaire track are at least partly extending along a circular path, a curved path, or an elliptical path.

7. The track lighting system according to claim 1, wherein the first luminaire track and the second luminaire track are extending along a straight path.

8. The track lighting system according to claim 1,
wherein the first track connector and/or the second track connector are click-fitted into the elongated system track.

9. The track lighting system according to claim 1,
wherein the first track connector comprises a first track connector locking mechanism to reversibly lock the first track connector to a fixed position on the elongated system track; and/or
wherein the first luminaire connector comprises a first luminaire connector locking mechanism to reversibly lock the first luminaire connector to a fixed position on the first luminaire track.

10. The track lighting system according to claim 1,
wherein the second track connector comprises a second track connector locking mechanism to reversibly lock the second track connector to a fixed position on the elongated system track; and/or
wherein the second luminaire connector comprises a second luminaire connector locking mechanism to reversibly lock the second luminaire connector to a fixed position on the second luminaire track.

11. The track lighting system according to claim 1, wherein the LED luminaire is a LED panel.

12. The track lighting system according to claim 1,
wherein the first luminaire track comprises a first slit embedded in the back panel of the luminaire, wherein the first luminaire connector is mechanically confined in the first slit of the first luminaire track; and/or
wherein the second luminaire track comprises a second slit embedded in the back panel of the luminaire, wherein the second luminaire connector is mechanically confined in the second slit of the second luminaire track.

13. The track lighting system according to claim 1, wherein the track lighting system comprises a third connector element;
wherein the third connector element comprises a third luminaire connector and a third track connector;
wherein the third luminaire connector is mechanically connected to the first luminaire track and is movable along the first luminaire track;
wherein the third track connector is mechanically connected to the elongated system track and is movable along said elongated system track.

14. The track lighting system according to claim 1, wherein the first connector element and/or the second connector element comprises a respective controllable hinge, wherein the respective controllable hinge is configured to hinge the first luminaire connector and the first track connector relative to each other and/or wherein the respective controllable hinge is configured to hinge the second luminaire connector and the second track connector relative to each other.

15. The track lighting system according to claim 1, wherein the track lighting system comprises (i) a ring shaped first luminaire track or (ii) the first luminaire track and the second luminaire track intersect each other, wherein the LED luminaire is rotatable over an axis A, wherein axis A extends perpendicular to said back panel of said LED luminaire.
